(19) United States
(12) Patent Application Publication
(10) Pub. No.: US 2023/0002642 A1
(43) Pub. Date: Jan. 5, 2023

(54) CURABLE COMPOSITION, TWO-LIQUID TYPE CURABLE COMPOSITION SET, AND METHOD FOR MANUFACTURING ADHERED PRODUCT

(71) Applicant: TOAGOSEI CO., LTD., Minato-ku, Tokyo (JP)

(72) Inventors: Michihiro KAAI, Nagoya-shi, Aichi (JP); Kento OOMURA, Nagoya-shi, Aichi (JP); Gen OKABE, Nagoya-shi, Aichi (JP)

(21) Appl. No.: 17/642,066

(22) PCT Filed: Sep. 10, 2020
(86) PCT No.: PCT/JP2020/034363

§ 371 Date: Mar. 10, 2022

(30) Foreign Application Priority Data
Sep. 10, 2019 (JP) 2019-164834

(51) Int. Cl. C09J 4/00; C09J 5/04

(52) U.S. Cl. CPC C09J 4/00; C09J 5/04

(57) ABSTRACT

A curable composition containing: a methylene malonate compound, and a Lewis acidic compound. The methylene malonate compound is preferably a compound represented by formula (1) or formula (2). In the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

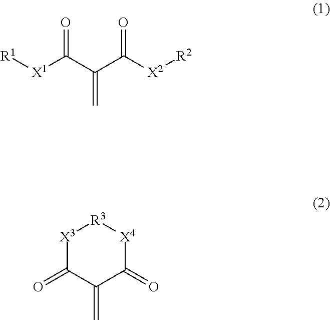

### TECHNICAL FIELD

The present invention relates to a curable composition, a two-liquid type curable composition set, and a method for manufacturing an adhered product.

### BACKGROUND ART

Curable compositions are widely used for applications such as adhesives, coating agents, sealants, and excipients. Polymerization reactions using a curable composition are classified into three types, i.e., radical polymerization, cationic polymerization, and anionic polymerization depending on active species generated during polymerization.

As the anionic polymerizable monomer, a cyanoacrylate compound such as 2-ethyl cyanoacrylate, a methylene malonate compound such as diethyl methylenemalonate, and the like are known.

It is known that the cyanoacrylate compound is rapidly polymerized by a weak base such as water.

On the other hand, in Non-Patent Document 1, it is expected that the dialkyl methylenemalonate compound does not exhibit anionic polymerizability by using a weak base such as water, unlike the cyanoacrylate compound, and the methylene malonate compound did not exhibit anionic polymerizability by using a weak base such as water also in the study of the present inventors.

Non-Patent Document 2 shows results of thermogravimetric analysis of a 2-ethyl cyanoacrylate homopolymer and a diethyl methylenemalonate homopolymer. It has been reported that the 2-ethyl cyanoacrylate homopolymer is reduced in weight by decomposition at a temperature of lower than 200° C., but that the diethyl methylenemalonate homopolymer is hardly reduced in weight even at 250° C., and tis excellent in heat resistance. Therefore, if curability of the methylene malonate compound can be improved, it is expected to be applicable to various applications as a material excellent in heat resistance.

Patent Documents 1 and 2 show methods for curing 1,1-dialkoxycarbonylethylene(methylene malonate).

Patent Document 3 shows a technique of adding a Lewis acidic metal salt for improving surface curability and clearance curability of 2-cyanoacrylates.

### CITATION LIST

### Non-Patent Documents

Non-Patent Document 1: J. Am. Chem. Soc., vol. 117, pp 3605-3610, 1995
Non-Patent Document 2: Polymer, vol. 39, No. 1, pp 173-181, 1998.

### Patent Documents

Patent Document 1: Japanese National-Phase Publication (JP-A) No. 2015-519416
Patent Document 2: JP-A No. 2015-512460
Patent Document 3: Japanese Patent Application Laid-Open (JP-A) No. 2000-290601

### SUMMARY OF INVENTION

### Technical Problem

A problem to be solved by the present invention is to provide a curable composition that can be cured by moisture content in the air and has a high curing rate, or a method for manufacturing an adhered product using the curable composition.

Another problem to be solved by the present invention is to provide a two-liquid type curable composition set which can be cured by moisture content in the air and has a high curing rate, or a method for manufacturing an adhered product using the two-liquid type curable composition set.

### Solution to Problem

Means for solving the problems include the following aspects.

<1> A curable composition containing: a methylene malonate compound; and a Lewis acidic compound.

<2> The curable composition according to <1>, wherein the methylene malonate compound is a compound represented by the following formula (1) or formula (2).

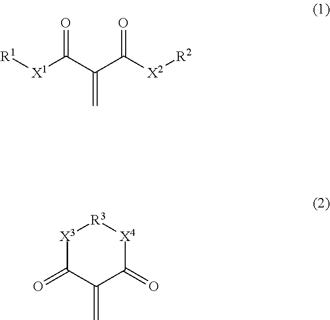

In the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

<3> The curable composition according to <1> or <2>, wherein the Lewis acidic compound includes a Lewis acidic compound having a metal cation.

<4> The curable composition according to any one of <1> to <3>, wherein the Lewis acidic compound includes a Lewis acidic compound having at least one metal cation selected from the group consisting of Fe²⁺, Cu²⁺, Zn²⁺, Ag⁺, Yb³⁺, and Ti⁴⁺.

<5> The curable composition according to any one of <1> to <4>, wherein the Lewis acidic compound includes a Lewis acidic compound having at least one counter anion selected from the group consisting of a trifluoromethanesulfonic acid anion, a tert-butoxide anion, an acetylacetonate anion, a chloride ion, and a bromide ion.

<6> The curable composition according to any one of <1> to <5>, wherein a content of the Lewis acidic compound is 0.001 parts by mass to 1.0 parts by mass with respect to 100 parts by mass of a content of the methylene malonate compound.

<7> The curable composition according to any one of <1> to <6>, wherein the X¹ to X⁴ are each independently O or NR.

<8> The curable composition according to any one of <1> to <7>, wherein the X¹ to X⁴ are O.

<9> The curable composition according to any one of <1> to <8>, wherein the R¹ and R² are each independently an alkyl group.

<10> The curable composition according to any one of <1> to <9>, wherein the R³ is an alkylene group.

<11> The curable composition according to any one of <1> to <10>, which contains the compound represented by the formula (1).

<12> A method for manufacturing an adhered product, including:

a step of applying the curable composition according to any one of <1> to <11> to a surface of a first adherend; and

a step of adhering the surface of the first adherend to which the curable composition has been applied and a surface of a second adherend to each other.

<13> A two-liquid type curable composition set including:

a composition A containing a methylene malonate compound; and

a composition B containing a Lewis acidic compound.

<14> The two-liquid type curable composition set according to <13>, wherein the methylene malonate compound is a compound represented by the following formula (1) or formula (2).

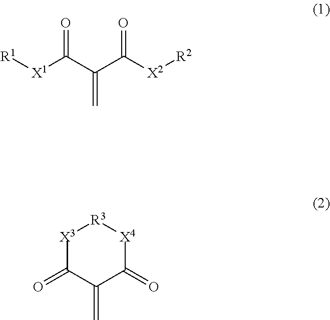

In the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

<15> A method for manufacturing an adhered product, comprising: a step of applying a composition B comprising a Lewis acidic compound to a surface of a first adherend; a step of applying a composition A comprising a methylene malonate compound to the surface of the first adherend or a surface of a second adherend; and a step of adhering the surface of the first adherend to which the composition B has been applied and the surface of the second adherend to which the composition A has been applied, or adhering the surface of the first adherend to which the composition A and the composition B have been applied and the surface of the second adherend to each other.

<16> The method for manufacturing an adhered product according to <15>, wherein the methylene malonate compound is a compound represented by the following formula (1) or formula (2).

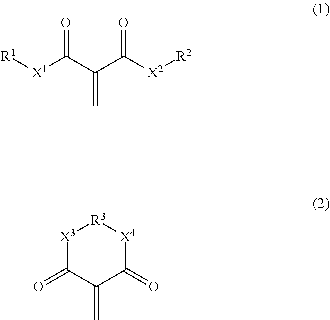

In the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

### Advantageous Effects of Invention

The present invention can provide a curable composition that can be cured by moisture content in the air and has a high curing rate, or a method for manufacturing an adhered product using the curable composition.

The present invention can provide a two-liquid type curable composition set that can be cured by moisture content in the air and has a high curing rate, and a method for manufacturing an adhered product using the two-liquid type curable composition set.

### DESCRIPTION OF EMBODIMENTS

The description of the components described below may be made based on representative embodiments of the present invention, but the present invention is not limited to such embodiments. As used herein, the term “to” is used to mean that numerical values indicated before and after the term “to” are included as a lower limit value and an upper limit value.

In the numerical ranges according to stages herein, the upper limit value or the lower limit value according to one numerical range may be replaced with the upper limit value or the lower limit value of any other numerical range according to stages. In addition, in the numerical ranges described herein, the upper limit values or the lower limit values of the numerical ranges may be replaced with values shown in Examples.

In the present invention, if there are a plurality of substances corresponding to each of components in a composition, the amount of each component in the composition means a total amount of the plurality of substances present in the composition unless otherwise specified.

In the present invention, the term “step” includes not only an independent step but also a step that cannot be clearly distinguished from other steps as long as the intended purpose of step is achieved.

In the present invention, the terms “mass %” and “weight %” have the same meaning, and the terms “parts by mass” and “parts by weight” have the same meaning.

In the present invention, a combination of two or more preferred embodiments is a more preferred embodiment.

In the present specification, “(meth)acryloyl” represents both or either one of acryloyl and methacryloyl, and “(meth)acryloxy” represents both or either one of acryloxy and methacryloxy.

Furthermore, in some of compounds in the present specification, hydrocarbon chains may be described as a simplified structural formula in which the symbols for carbon (C) and hydrogen (H) are omitted.

In the present invention, “applying” means that an operation is performed such that at least a part of a curable composition is in contact with a surface of an adherend, or an operation is performed such that at least a part of a composition A and/or a composition B are/is in contact with the surface of the adherend.

Specifically, it is possible to exemplify covering a part or the whole of the surface of the adherend with the curable composition or covering a part or the whole of the surface of the adherend with the composition A and/or the composition B using coating, filling, and other means.

Hereinafter, contents of the present invention will be according to detail.

(Curable Composition)

The curable composition of the present invention contains: a methylene malonate compound; and a Lewis acidic compound.

For example, for a conventional curable composition containing a methylene malonate compound, only a method of curing the composition by using a polymerization initiator, or a method of mixing a basic compound immediately before curing, as in the invention described in Patent Document 1 or Patent Document 2, was known.

As a result of intensive studies, the present inventors have found that, by forming a curable composition containing a methylene malonate compound and a Lewis acidic compound, the composition can be cured by anionic polymerization by moisture content in the air without using a polymerization initiator or a basic compound, and has a high curing rate.

Although the detailed reaction mechanism is unknown, it is presumed that, the Lewis acidic compound is coordinated to an oxygen atom of one or two carbonyl groups in the methylene malonate compound, so that anionic polymerization activity of the methylene malonate compound is improved, and that anionic polymerization can also be performed by moisture content in the air.

In particular, it was not known at all that the methylene malonate compound is anionically polymerized by the moisture content in the air, and this has been found for the first time.

In addition, the cured product obtained by curing the curable composition of the present invention contains a methylene malonate compound, and thus is also excellent in heat resistance.

Hereinafter, the present invention will be described in detail.

<Methylene Malonate Compound>

The curable composition of the present invention contains a methylene malonate compound.

The methylene malonate compound is a compound having a —CO—C(═CH₂)—CO— structure as shown in the following formula (1) or formula (2).

Especially, the methylene malonate compound is preferably a compound represented by the following formula (1) or formula (2), and preferably a methylene malonate compound represented by the following formula (1), from the viewpoint of reaction rate and storage stability.

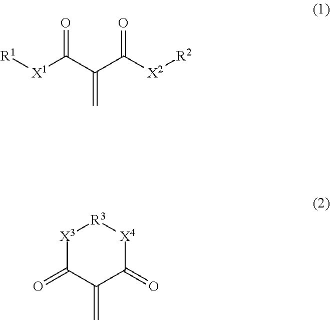

In the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

X¹ to X⁴ in the formula (1) and the formula (2) are each independently preferably O or NR, more preferably O or NH, and particularly preferably O from the viewpoint of heat resistance, reaction rate, and storage stability.

X¹ and X² in the formula (1) are preferably the same group from the viewpoint of heat resistance, reaction rate, and storage stability.

X³ and X⁴ in the formula (2) are preferably the same group from the viewpoint of heat resistance, reaction rate, and storage stability.

R's in the formula (1) and the formula (2) are each independently preferably a hydrogen atom, an alkyl group having 1 to 20 carbon atoms (also referred to as “number of carbon atoms”), or an aryl group having 6 to 20 carbon atoms, more preferably a hydrogen atom, an alkyl group having 1 to 10 carbon atoms, or a phenyl group, further preferably a hydrogen atom or an alkyl group having 1 to 6 carbon atoms, and particularly preferably a hydrogen atom.

That is, NR is particularly preferably NH, and C(R)₂ is particularly preferably CH₂.

R¹ and R² in the formula (1) are each independently preferably an alkyl group having 1 to 20 carbon atoms or an aryl group having 6 to 20 carbon atoms, more preferably an alkyl group having 1 to 20 carbon atoms, further preferably an alkyl group having 1 to 10 carbon atoms, particularly preferably an alkyl group having 1 to 3 carbon atoms, and most preferably a methyl group or an ethyl group, from the viewpoint of heat resistance, reaction rate, and storage stability.

Further, R¹ and R² in the formula (1) are each independently preferably an alkyl group from the viewpoint of heat resistance, reaction rate, and storage stability.

Further, R¹ and R² in the formula (1) are each independently preferably an alkyl group from the viewpoint of heat resistance, reaction rate, and storage stability.

Furthermore, R¹ and R² in the formula (1) are preferably the same group from the viewpoint of heat resistance, reaction rate, and storage stability.

From the viewpoint of reaction rate, R³ in the formula (2) is preferably an alkylene group having 1 to 20 carbon atoms, an arylene group having 6 to 20 carbon atoms, or a group having 7 to 20 carbon atoms obtained by combining one or more alkylene groups and one or more arylene groups, more preferably an alkylene group having 1 to 20 carbon atoms, further preferably an alkylene group having 1 to 10 carbon atoms, and particularly preferably a methylene group, an ethylene group, or a dimethylmethylene group.

R³ in the formula (2) is preferably an alkylene group from the viewpoint of reaction rate.

The alkyl group or alkylene group of each group in the formula (1) and the formula (2) may be linear, branched, cyclic, or substituted.

Examples of the substituent which the alkyl group or the alkylene group may have include an aryl group, an alkoxy group, an alkoxycarbonyl group, and an acyl group.

The aryl group or the arylene group of each group in the formula (1) and the formula (2) may have a substituent.

Examples of the substituent which the aryl group or the arylene group may have include an alkyl group, an aryl group, an alkoxy group, an alkoxycarbonyl group, and an acyl group.

Preferred specific examples of the methylene malonate compound represented by the formula (1) include dialkyl 2-methylene malonate such as dimethyl 2-methylene malonate, diethyl 2-methylene malonate, dibutyl 2-methylene malonate, 1-methyl-3 hexyl 2-methylene malonate, and dicyclohexyl 2-methylene malonate.

Among them, diethyl 2-methylenemalonate is particularly preferable.

Preferred specific examples of the methylene malonate compound represented by the formula (2) include 5-methylene-1,3-dioxane-4, 6-dione compounds such as 5-methylene-1, 3-dioxane-4, 6-dione and 2,2-dimethyl-5-methylene-1,3-dioxane-4, 6-dione.

The curable composition of the present invention may contain one of the methylene malonate compounds represented by the formula (1) alone or two or more thereof, or one of the methylene malonate compounds represented by the formula (2) alone or two or more thereof, or one or more of the methylene malonate compounds represented by the formula (1) and one or more of the methylene malonate compounds represented by the formula (2).

A content of the methylene malonate compound in the curable composition of the present invention is preferably 10 mass % to 99.999 mass %, more preferably 30 mass % to 99.99 mass %, further preferably 50 mass % to 99.95 mass %, and particularly preferably 90 mass % to 99.95 mass % with respect to a total solid content of the curable composition.

In the present specification, “total solid content” refers to a total mass of components obtained by removing a solvent from all components of the composition. As described above, “solid content” is a component excluding a solvent, and may be, for example, a solid or a liquid at 25° C.

<Lewis Acidic Compound>

The curable composition of the present invention includes a Lewis acidic compound.

The Lewis acidic compound used in the present invention is preferably a Lewis acidic compound capable of acting on, for example, coordinating to the methylene malonate compound.

From the viewpoint of curing rate and storage stability, the Lewis acidic compound preferably includes a Lewis acidic compound having a metal cation, more preferably includes a Lewis acidic compound having a monovalent to tetravalent metal cation, and particularly preferably includes a Lewis acidic compound having a monovalent to trivalent metal cation.

The metal cation is preferably a metal cation of Group 3 to Group 12, more preferably at least one metal cation selected from the group consisting of Fe²⁺, Cu²⁺, Zn²⁺, Ag⁺, Yb³⁺, Ti⁴⁺, Zr⁴⁺, Hf⁴⁺, In³⁺, Au⁺, Sn⁴⁺, Cd²⁺, Ni²⁺, Mn²⁺, Co²⁺, Cr²⁺, and Ga²+, particularly preferably at least one metal cation selected from the group consisting of Fe²⁺, Cu²⁺, Zn²⁺, Ag⁺, Yb⁴⁺, and Ti⁴⁺, and most preferably at least one metal cation selected from the group consisting of Cu²⁺, Zn²⁺, and Ag⁺, from the viewpoint of curing rate and storage stability.

The Lewis acidic compound is preferably a salt of a metal cation and a counter anion from the viewpoint of curing rate and storage stability.

Further, from the viewpoint of curing rate and storage stability, the Lewis acidic compound preferably includes a Lewis acidic compound having at least one counter anion selected from the group consisting of a sulfonate ion, a hypochlorite ion, an alkoxide anion, a 1,3-diketonate anion, and a halide ion, more preferably includes a Lewis acidic compound having at least one counter anion selected from the group consisting of a trifluoromethanesulfonate anion, a methanesulfonate anion, a tosylate anion, a benzenesulfonate anion, a hypochlorite anion, a tert-butoxide anion, an acetylacetonate anion, a chloride ion, and a bromide ion, further preferably includes a Lewis acidic compound having at least one counter anion selected from the group consisting of a trifluoromethanesulfonate anion, a methanesulfonate anion, a tert-butoxide anion, a chloride ion, an acetylacetonate anion, and a bromide ion, and particularly preferably includes a Lewis acidic compound having a trifluoromethanesulfonate anion.

Specific examples of the Lewis acidic compound preferably include copper (II) trifluoromethanesulfonate, zinc (II) trifluoromethanesulfonate, silver (I) trifluoromethanesulfonate, ytterbium (III) trifluoromethanesulfonate, titanium (IV) butoxide, titanium (IV) tert-butoxide, copper (II) chloride, copper (II) bromide, zinc (II) chloride, and zinc (II) bromide.

Among them, copper (II) trifluoromethanesulfonate, zinc (II) trifluoromethanesulfonate, silver (I) trifluoromethanesulfonate, or ytterbium (III) trifluoromethanesulfonate is more preferable, and copper (II) trifluoromethanesulfonate, zinc (II) trifluoromethanesulfonate, or silver (I) trifluoromethanesulfonate is particularly preferable, from the viewpoint of curing rate and storage stability.

The curable composition of the present invention may contain one Lewis acidic compound alone or two or more Lewis acidic compounds.

A content of the Lewis acidic compound in the curable composition of the present invention is preferably 0.001 parts by mass to 1.0 parts by mass, more preferably 0.001 parts by mass to 0.5 parts by mass, and particularly preferably 0.001 parts by mass to 0.1 parts by mass, with respect to 100 parts by mass of a content of the methylene malonate compound.

<Polymerization Inhibitor>

From the viewpoint of storage stability, the curable composition of the present invention preferably contains a polymerization inhibitor, and more preferably contains a radical polymerization inhibitor.

The polymerization inhibitor preferably includes a phenolic radical polymerization inhibitor from the viewpoint of storage stability. The phenolic radical polymerization inhibitor is preferably at least one selected from the group consisting of hydroquinone, mequinol, butylhydroxyanisole, di-tert-butylhydroxytoluene, methylhydroquinone, methoxyhydroquinone, 2,6-dimethylhydroquinone, 2,6-di-tert-butylhydroquinone, 4-tert-butylcatechol, tert-butylhydroquinone, 6-tert-butyl-4-xylenol, 2,6-di-tert-butylphenol, and 1,2,4-trihydroxybenzene, and particularly preferably at least one selected from the group consisting of hydroquinone, methylhydroquinone, methoxyhydroquinone, 2,6-dimethylhydroquinone, and 2,6-di-tert-butylhydroquinone, which are radical polymerization inhibitors having a hydroquinone structure.

Preferable examples of the polymerization inhibitor include anionic polymerization inhibitors such as diphosphorus pentoxide, SO₂, p-toluenesulfonic acid, methanesulfonic acid, propane sultone, and a BF₃ complex.

As the polymerization inhibitor, a radical polymerization inhibitor having a hydroquinone structure and an anionic polymerization inhibitor are preferably used in combination, from the viewpoint of storage stability.

From the viewpoint of storage stability, the polymerization inhibitor preferably includes a polymerization inhibitor having a phenolic hydroxy group, more preferably is a compound represented by the following formula (In1), and particularly preferably is a compound represented by the following formula (In2).

As the polymerization inhibitor, it is particularly preferable to use a radical polymerization inhibitor having a hydroquinone structure, an anionic polymerization inhibitor, and a polymerization inhibitor having a phenolic hydroxy group in combination, from the viewpoint of storage stability.

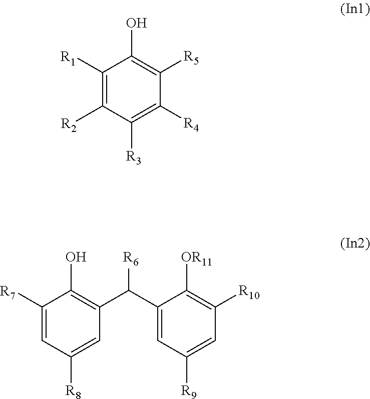

In the formula (In1) and the formula (In2). R₁ to R₅ each independently represent a hydrogen atom or a substituent other than a hydroxy group (provided that phenolic hydroxy groups are excluded), which may be bonded to each other to form a ring, R₆ represents a hydrogen atom or an alkyl group, R₇ to R₁₀ each independently represent an alkyl group, a cycloalkyl group, or an alkenyl group, and R₁₁ represents a hydrogen atom or a (meth)acryloyl group.

In the formula (In1), from the viewpoint of storage stability, at least one of R₁ to R₅ is preferably the substituent described above, R₁ and R₅ are more preferably at least the substituents described above, and R₁, R₃ and R₅ are particularly preferably at least the substituents described above.

From the viewpoint of storage stability, preferably, R₁ and R₅ in the formula (In1) are each independently a linear or branched alkyl group, a cycloalkyl group, an alkyl group having a structure having a phenolic hydroxy group, or an alkyl group having a (meth)acryloxyphenyl structure; more preferably, R₁ is a linear or branched alkyl group, and R₅ is an alkyl group having a structure having a phenolic hydroxy group or an alkyl group having a (meth)acryloxyphenyl structure; and, particularly preferably, R₁ is a linear or branched alkyl group, and R₅ is an alkyl group having a (meth)acryloxyphenyl structure.

R₃ in the formula (In1) is preferably a hydrogen atom, an alkyl group, or an alkoxy group, more preferably a linear or branched alkyl group, a cycloalkyl group, or an alkoxy group, and further preferably a linear or branched alkyl group or an alkoxy group, from the viewpoint of storage stability.

The alkyl group in the R₁, R₃, and R₅ is preferably an alkyl group having 1 to 8 carbon atoms, more preferably an alkyl group having 1 to 6 carbon atoms, further preferably a linear or branched alkyl group having 1 to 6 carbon atoms, a cycloalkyl group having 1 to 6 carbon atoms, a t-butyl group, or a 2-methyl-2-butyl group, and particularly preferably a methyl group, a t-butyl group, or a 2-methyl-2 butyl group.

The alkyl group may be linear, branched, cyclic, or substituted.

The substituent may be any group that does not lose the polymerization inhibiting ability, and examples thereof include a halogen atom, an alkoxy group, and an aryl group. The substituent may be further substituted with at least one group selected from the group consisting of the substituents described above and alkyl groups.

In the formula (In1), R₂ and R₄ are each independently preferably a hydrogen atom or an alkyl group, and more preferably a hydrogen atom.

R₆ in the formula (In2) is preferably a hydrogen atom or an alkyl group having 1 to 8 carbon atoms, and more preferably a hydrogen atom or a methyl group, from the viewpoint of storage stability.

R₇ and R₁₀ in the formula (In2) are preferably tertiary alkyl groups, more preferably tertiary alkyl groups having 4 to 8 carbon atoms, and particularly preferably t-butyl groups or 2-methyl-2-butyl groups, from the viewpoint of storage stability.

R₈ and R₉ in the formula (In2) are preferably alkyl groups having 1 to 8 carbon atoms, and more preferably methyl groups, t-butyl groups, 2-methyl-2-butyl groups, methoxy groups, ethoxy groups, propoxy groups, or butoxy groups, from the viewpoint of storage stability.

R₁₁ in the formula (In2) is preferably a hydrogen atom or a (meth)acryloyl group, from the viewpoint of storage stability.

Among them, from the viewpoint of storage stability, the polymerization inhibitor having a phenolic hydroxy group is preferably at least one compound selected from the group consisting of 2,2′-methylenebis(6-tert-butyl-p-cresol), 2,2′-methylenebis(4-ethyl-6-tert-butyl-phenol), 2,2′-methylenebis(4-methyl-6 tert-butylphenol)monoacrylate, 2,2′-ethylenebis(4,6-di-tert-amylphenol)monoacrylate, and 2,2′-methylenebis(6-(1-methylcyclohexyl)-p-cresol).

The curable composition of the present invention may contain one of the polymerization inhibitors alone or two or more thereof.

From the viewpoint of storage stability, a content of the polymerization inhibitor in the curable composition of the present invention is preferably 0.01 parts by mass to 20 parts by mass, more preferably 0.05 parts by mass to 10 parts by mass, and particularly preferably 0.1 parts by mass to 5 parts by mass, with respect to 100 parts by mass of the content of the methylene malonate compound.

<Other Components>

The curable composition of the present invention may further contain other components depending on its use. For example, other anionic polymerizable compounds other than the methylene malonate compound, radical polymerizable compounds, photopolymerization initiators, solvents, anionic polymerization accelerators, plasticizers, thickeners, sensitizers, adhesion imparting agents (such as silane coupling agents) and the like can be contained.

Furthermore, examples of other additives include fillers, pigments, dyes, leveling agents, antifoaming agents, antistatic agents, ultraviolet absorbers, pH adjusting agents, dispersants, dispersion aids, surface modifiers, plasticizers, antisagging agents, curing accelerators, viscoelasticity modifiers, antibacterial agents, optical brighteners, and antioxidants. Among them, one or more thereof can be used in combination.

The other anionic polymerizable compounds are not particularly limited as long as the effect of the present invention can be exhibited. Examples of the other anionic polymerizable compounds include cyanoacrylates such as 2-ethyl cyanoacrylate, and epoxy-based compounds (for example, a compound having two or more glycidyl groups, such as bisphenol A diglycidyl ether).

The radical polymerizable compound is not particularly limited as long as the effect of the present invention can be exhibited. Examples of the radical polymerizable compound include (meth)acrylate compounds and (meth)acrylamide compounds.

The curable composition of the present invention may contain a polymerization initiator in order to assist or accelerate curing. When the curable composition contains a radical polymerizable compound, the curable composition preferably further contains a radical polymerization initiator, and more preferably further contains a photoradical generator. As the photoradical generator, a known photoradical generator used in photopolymerization of a radical polymerizable compound can be used.

Examples of the photoradical generator include acylgermane-based compounds, acylphosphine oxide-based compounds, acetophenone-based compounds having no hydroxy group, nitrogen atom, or thioether bond, and benzoin-based compounds having no hydroxy group, nitrogen atom, or thioether bond.

Among them, the photoradical generator is preferably an acylgermane-based compound from the viewpoint of photocurability, adhesion rate, and storage stability. As the acylgermane compound, a monoacylgermane-based compound and a bisacylgermane-based compound are preferable, and a bisacylgermane-based compound is more preferable.

Preferred examples of the acylgermane-based compound include Ivocerin (manufactured by Ivoclar Vivadent).

Preferred examples of the acylphosphine oxide-based compound include a monoacylphosphine oxide-based compound and a bisacylphosphine oxide-based compound, and more preferred examples thereof include a bisacylphosphine oxide-based compound.

The curable composition of the present invention may contain one photoradical generator alone or two or more photoradical generators.

A content of the polymerization initiator in the curable composition of the present invention is preferably 0.01 mass % to 5 mass %, more preferably 0.05 mass % to 2 mass %, and particularly preferably 0.05 mass % to 1 mass % with respect to the total solid content of the curable composition from the viewpoint of photocurability and storage stability.

The solvent is not particularly limited as long as the effect of the present invention can be exhibited. Examples of the solvent include aromatic hydrocarbon-based solvents such as benzene, toluene, and xylene; saturated hydrocarbon-based solvent such as hexane, cyclohexane, and heptane; ether-based solvents of diethyl ether, diisopropyl ether, tetrahydrofuran, dioxane, ethylene glycol monomethyl ether, and propylene glycol monomethyl ether: ketone-based solvents such as acetone, methyl ethyl ketone, and methyl isobutyl ketone: ester-based solvents such as ethyl acetate, butyl acetate, and propylene glycol monomethyl ether acetate; and halogenated hydrocarbon-based solvents such as chloroform. Among them, one or more thereof can be used in combination.

When the curable composition contains a solvent, a content of the solvent is preferably 1 part by mass to 1,000 parts by mass, more preferably 1 part by mass to 500 parts by mass, and particularly preferably 1 part by mass to 300 parts by mass, with respect to 100 parts by mass of the content of the methylene malonate compound.

Examples of the anionic polymerization accelerator include polyalkylene oxides, crown ethers, silacrown ethers, calixarenes, cyclodextrins, and pyrogallol-based cyclic compounds. The polyalkylene oxides are polyalkylene oxides and derivatives thereof, and examples thereof include those disclosed in Japanese Patent Publication (JP-B) No. S60-37836, JP-B No. H1-43790, JP-A No. S63-128088, JP-A No. H3-167279, U.S. Pat. Nos. 4,386,193 A, 4,424,327 A, and the like. Specific examples of the polyalkylene oxides include (1) polyalkylene oxides such as diethylene glycol, triethylene glycol, polyethylene glycol, and polypropylene glycol, and (2) derivatives of polyalkylene oxides such as polyethylene glycol monoalkyl ester, polyethylene glycol dialkyl ester, polypropylene glycol dialkyl ester, diethylene glycol monoalkyl ether, diethylene glycol dialkyl ether, dipropylene glycol monoalkyl ether, and dipropylene glycol dialkyl ether. Examples of the crown ethers include those disclosed in JP-B No. S55-2236, JP-A No. H3-167279, and the like. Specific examples thereof include 12-crown-4, 15-crown-5, 18-crown-6, benzo-12-crown-4, benzo-15-crown-5, benzo-18-crown-6, dibenzo-18-crown-6, dibenzo-24-crown-8, dibenzo-30-crown-10, tribenzo-18-crown-6, asym dibenzo-22-crown-6, dibenzo-14-crown-4, dicyclohexyl-24-crown-8, cyclohexyl-12-crown-4, 1,2-decaryl-15-crown-5, 1,2-naphtho-15-crown-5, 3,4,5-naphthyl-16-crown-5, 1,2-methylbenzo-18-crown-6, 1,2-tert-butyl-18-crown-6, and 1,2-vinylbenzo-15-crown-5. Examples of the silacrown ethers include those disclosed in JP-A No. S60-168775 and the like. Specific examples of the silacrown ethers include dimethylsila-11-crown-4, dimethylsila-14-crown-5, and dimethylsila-17-crown-6. Examples of the calixarenes include those disclosed in JP-A No. S60-179482, JP-A No. S62-235379, JP-A No. S63-88152, and the like. Specific examples of the calixarenes include 5,11,17,23,29,35-hexa-tert-butyl-37,38,39,40,41,42-hexahvdrooxycalix[6]arene, 37,38,39,40,41,42-hexahydrooxycalix[6]arene, 37,38,39,40,41,42-hexa-(2-oxo-2-ethoxy)-ethoxycalix[6]arene, 25,26,27,28-tetra-(2-oxo-2-ethoxy)-ethoxycalix[4]arene, and tetrakis(4-t-butyl-2-methylenephenoxy)ethyl acetate. Examples of the cyclodextrins include those disclosed in JP-A No. H5-505835 and the like. Specific examples of the cyclodextrins include α-, β- and γ-cyclodextrins. Examples of the pyrogallol cyclic compounds include compounds disclosed in JP-A No. 2000-191600 and the like. Specific examples of the pyrogallol cyclic compounds include 3,4,5,10,11,12,17,18,19,24,25,26-dodecaethoxycarbomethoxy-C-1,C-8,C-15,C-22-tetramethyl[14]metacyclophane. These anionic polymerization accelerators may be used singly, or two or more thereof may be used in combination.

The plasticizer can be contained as long as the effect of the present invention is not impaired.

Examples of this plasticizer include triethyl acetylcitrate, tributyl acetylcitrate, dimethyl adipate, diethyl adipate, dimethyl sebacate, dimethyl phthalate, diethyl phthalate, dibutyl phthalate, diisodecyl phthalate, dihexyl phthalate, diheptyl phthalate, dioctyl phthalate, bis(2-ethylhexyl)phthalate, diisononyl phthalate, diisotridecyl phthalate, dipentadecyl phthalate, dioctyl terephthalate, diisononyl isophthalate, decyl toluate, bis(2-ethylhexyl)camphorate, 2-ethylhexylcyclohexylcarboxylate, diisobutyl fumarate, diisobutyl maleate, triglyceride caproate, 2-ethylhexyl benzoate, and dipropylene glycol dibenzoate. Among them, tributyl acetylcitrate, dimethyl adipate, dimethyl phthalate, 2-ethylhexyl benzoate, and dipropylene glycol dibenzoate are preferable from the viewpoint of good compatibility with 2-cyanoacrylic acid esters and high plasticization efficiency. These plasticizers may be used singly, or two or more thereof may be used in combination. A content of the plasticizer is not particularly limited, but is preferably 3 parts by mass to 50 parts by mass, more preferably 10 parts by mass to 45 parts by mass, and further preferably 20 parts by mass to 40 parts by mass when the content of the methylene malonate compound is 100 parts by mass. When the content of the plasticizer is 3 parts by mass to 50 parts by mass, it is possible to improve retention of adhesive strength after a hot-cold cycle resistance test.

Further, examples of the thickener include polymethyl methacrylate, a copolymer of methyl methacrylate and an acrylic acid ester, a copolymer of methyl methacrylate and any other methacrylic acid ester, acrylic rubber, polyvinyl chloride, polystyrene, a cellulose ester, polyalkyl-2 cyanoacrylic acid ester, and an ethylene-vinyl acetate copolymer. These thickeners may be used singly, or two or more thereof may be used in combination.

The curable composition of the present invention can also contain fumed silica as the filler or the like.

The fumed silica is an ultrafine powdery (a primary particle size thereof is preferably 500 nm or less, and particularly preferably 1 nm to 200 nm) anhydrous silica. The anhydrous silica is, for example, an ultrafine powdery (a primary particle size thereof is preferably 500 nm or less, and particularly preferably 1 nm to 200 nm) anhydrous silica produced due to oxidation in a gas phase state in a high-temperature flame using silicon tetrachloride as a raw material, and includes hydrophilic silica having high hydrophilicity and hydrophobic silica having high hydrophobicity. Any fumed silica can be used, but hydrophobic silica is preferable from the viewpoint of good dispersibility in the methylene malonate compound.

As the hydrophilic silica, various commercially available products can be used, and examples thereof include AEROSIL 50, 130, 200, 300, and 380 (all trade names, manufactured by Nippon Aerosil Co., Ltd.). Specific surface areas of these hydrophilic silicas are 50±15 m²/g, 130±25 m²/g, 200±25 m²/g, 300±30 m²/g, and 380±30 m²/g, respectively. As commercially available hydrophilic silica, for example, REOLOSIL QS-10, QS-20, QS-30, and QS-40 (all trade names, manufactured by Tokuyama Corporation) can be used. Specific surface areas of these hydrophilic silicas are 140±20 m²/g, 220±20 m²/g, 300±30 m²/g, and 380±30 m²/g, respectively. In addition, commercially available hydrophilic silica such as manufactured by CABOT can also be used.

Furthermore, as the hydrophobic silica, a product produced by bringing a compound capable of reacting with a hydroxy group present on a surface of the hydrophilic silica to form a hydrophobic group or a compound capable of adsorbing on a surface of the hydrophilic silica to form a hydrophobic layer on the surface into contact with the hydrophilic silica in the presence or absence of a solvent, and preferably heating the contacted silicas to treat the surface of the hydrophilic silica can be used.

Examples of the compound used for hydrophobizing the hydrophilic silica by surface treatment include various alkyl, aryl, and aralkyl-based silane coupling agents having a hydrophobic group such as n-octyllyalkoxysilane: silylating agents such as methyltrichlorosilane, dimethyldichlorosilane, and hexamethyldisilazane; silicone oils such as polydimethylsiloxane; higher alcohols such as stearyl alcohol; and higher fatty acids such as stearic acid. As the hydrophobic silica, a product hydrophobized using any compound may be used.

Examples of the commercially available hydrophobic silica include AEROSIL RY 200 and R202 which are surface-treated with silicone oil and hydrophobized, AEROSIL R974 and R972 and R976 which are surface-treated with a dimethylsilylating agent and hydrophobized, AEROSIL R805 which is surface-treated with n-octyltrimethoxysilane and hydrophobized, and AEROSIL R811 and R812 which are surface-treated with a trimethylsilylating agent and hydrophobized (all trade names, manufactured by Nippon Aerosil Co., Ltd.); and REOLOSIL MT-10 which is surface-treated with methyltrichlorosilane and hydrophobized (trade name, manufactured by Tokuyama Corporation). Specific surface areas of these hydrophobic silicas are 100±20 m²/g, 100±20 m²/g, 170±20 m²/g, 110±20 m²/g, 250±25 m²/g, 150±20 m²/g, 150±20 m²/g, 260±20 m²/g, and 120±10 m²/g, respectively.

A content of the fumed silica in the curable composition of the present invention is preferably 1 part by mass to 30 parts by mass when the content of the methylene malonate compound is 100 parts by mass. The content of the fumed silica is preferably 1 part by mass to 25 parts by mass, and particularly preferably 2 parts by mass to 20 parts by mass, although it depends on the type of methylene malonate compound, the type of fumed silica, and the like. Within the above ranges, an adhesive composition having good workability can be obtained.

<Method for Manufacturing Curable Composition>

A method for manufacturing the curable composition of the present invention is not particularly limited, and the respective components may be mixed to produce the curable composition, but it is preferable to mix the components in an atmosphere without or with little (for example, 0.01 vol % or less) moisture and oxygen, and it is more preferable to mix the components in an inert gas atmosphere.

Examples of the inert gas include nitrogen and argon.

In addition, the method for manufacturing the curable composition of the present invention is preferably performed under light shielding.

A method for the mixing is not particularly limited, and a known mixing method can be used.

<Method for Storing Curable Composition>

As a method for storing the curable composition of the present invention, the curable composition may be stored by a known storage method. For example, it is preferable to store the curable composition in an atmosphere without or with little moisture and oxygen (for example, 0.01 vol % or less) or in a sealed container, and it is more preferable to store the curable composition in an inert gas atmosphere or in a sealed container.

Examples of the inert gas include nitrogen and argon.

In addition, the curable composition of the present invention is preferably stored under light shielding.

<Method for Curing Curable Composition>

A method for curing the curable composition of the present invention is not particularly limited as long as the curable composition can be polymerized and cured with the methylene malonate compound, and the curable composition may be cured with the moisture content such as moisture or may be cured with light, but is preferably cured with the moisture content such as moisture.

When the curable composition of the present invention is cured with light, the curable composition can be cured upon irradiation with ultraviolet rays or visible rays using a high-pressure mercury lamp, a halogen lamp, a xenon lamp, an LED (light emitting diode) lamp, sunlight, or the like.

<Application>

The curable composition of the present invention can be used for applications of known curable compositions.

For example, it can be suitably used as a so-called instant adhesive.

The curable composition of the present invention has moisture curability and excellent storage stability, and thus can be used in a wide range of fields such as general use, industrial use, and medical use.

Examples of the applications include, but are not limited to, adhesives, coating agents (protective coating agents and the like), printing inks (inkjet inks and the like), photoresists, and sealants.

Specifically, the curable composition can be suitably used for, for example, sealing of an electronic component, attachment of a reel sheet, a thread passing guide, or the like in a fishing rod, fixation of a wire material such as a coil, fixation of a magnetic head to a pedestal, a filler used for tooth treatment, adhesion and fixation between articles of the same kind or different kinds, such as adhesion or decoration of an artificial nail, or coating.

<Method for Manufacturing Adhered Product Using Curable Composition>

The curable composition of the present invention can be preferably used in the following first embodiment of the method for manufacturing an adhered product of the present invention.

The first embodiment of the method for manufacturing an adhered product of the present invention includes a step of applying the curable composition of the present invention to a surface of a first adherend (hereinafter, also referred to as a “curable composition application step”), and a step of adhering the surface of the first adherend to which the curable composition has been applied and a surface of a second adherend to each other to obtain an adhered product (hereinafter, also referred to as a “first adhesion step”).

In the curable composition application step, the curable composition of the present invention may be applied only to the surface of one adherend (the surface of the first adherend), or the curable composition of the present invention may be applied to both the surface of one adherend (the surface of the first adherend) and the surface of the other adherend (the surface of the second adherend).

Further, the surface of the first adherend and the surface of the second adherend may be partial surfaces of different adherends, or may be two surfaces that can be adhered in one adherend.

Shapes of the surface of the first adherend and the surface of the second adherend are not particularly limited, and may be any shapes such as flat surfaces, uneven surfaces, or surfaces having an indefinite shape.

Examples of the material for the adherend include plastic, rubber, wood, metals, inorganic materials, and paper.

Specific examples of the plastic include cellulose acetate resins such as polyvinyl alcohol, triacetyl cellulose, and diacetyl cellulose, cyclic polyolefin resins using a cyclic olefin as a monomer such as acrylic resins, polyethylene terephthalate, polycarbonate, polyarylate, polyether sulfone, and norbornene, polyvinyl chloride, epoxy resins, and polyurethane resins.

Specific examples of the rubber include natural rubber and styrene-butadiene rubber (SBR).

Specific examples of the wood include natural wood and synthetic wood.

Specific examples of the metal include steel plates, metals such as aluminum and chromium, and metal oxides such as zinc oxide (ZnO) and indium tin oxide (ITO).

Specific examples of the inorganic material include glass, mortar, concrete, and stone.

Specific examples of the paper include paper such as fine paper, coated paper, art paper, simili paper, thin paper, and thick paper, and various synthetic papers.

In the curable composition application step, the method for applying the curable composition to the surface of the adherend is not particularly limited.

Examples of an application method include methods of using application tools such as brush, spatula, cotton swab, roller, and spray, and methods of coating with coating machines such as a bar coater, an applicator, a doctor blade, a dip coater, a roll coater, a spin coater, a flow coater, a knife coater, a comma coater, a reverse roll coater, a die coater, a lip coater, a spray coater, a gravure coater, a microgravure coater, and a dispenser.

Thereafter, in the first adhesion step, the surface of the first adherend and the surface of the second adherend are bonded to each other, and the curable composition of the present invention is cured to adhere the first and second adherends to obtain an adhered product.

In the first adhesion step, the curable composition can be cured even at room temperature (for example, 10° C. to 35° C.), but, in order to promote curing, the surface of the first adherend, the surface of the second adherend, and/or the adherends may be heated. Curing may be performed by heating to a temperature within a range not affecting the adherend, for example, about 35° C. to 100° C. as the heating temperature.

Furthermore, in the first adhesion step, as necessary, pressure may be applied in a direction in which the surface of the first adherend and the surface of the second adherend overlap each other until adhesion is completed.

(Two-Liquid Type Curable Composition Set)

The two-liquid type curable composition set of the present invention includes: a composition A containing a methylene malonate compound; and a composition B containing a Lewis acidic compound.

For example, the composition A and the composition B can be applied to surfaces of adherends, preferably the composition A and the composition B can be applied to the surface of one adherend, or the composition A can be applied to the surface of one adherend, and the composition B can be applied to the surface of the other adherend, and, according to need, a solvent can be removed, and the surfaces of the two adherends can be overlapped, and cured and adhered.

Preferred aspects of the methylene malonate compound of the composition A and preferred aspects of the Lewis acidic compound of the composition B in the two-liquid type curable composition set of the present invention are the same as the preferred aspects of the methylene malonate compound and the preferred aspects of the Lewis acidic compound in the curable composition of the present invention described above, except for the features which will be described below.

Further, the composition A and the composition B in the two-liquid type curable composition set of the present invention may each independently contain the polymerization inhibitor and/or the other components.

Preferred aspects of the polymerization inhibitor and the other components in the two-liquid type curable composition set of the present invention are the same as the preferred embodiments of the polymerization inhibitor and the other components in the curable composition of the present invention described above.

A content of the methylene malonate compound in the composition A is preferably 10 mass % to 100 mass %, more preferably 30 mass % to 100 mass %, further preferably 50 mass % to 100 mass %, and particularly preferably 90 mass % to 100 mass % with respect to a total solid content of the composition A.

A content of the Lewis acidic compound in the composition B is preferably 1 mass % to 100 mass %, more preferably 10 mass % to 100 mass %, and particularly preferably 50 mass % to 100 mass %, with respect to a total solid content of the composition B.

The composition B preferably contains a solvent. Suitable examples of the solvent include those described above for the curable composition of the present invention.

A content of the solvent in the composition B is preferably 10 mass % to 99.99 mass %, more preferably 50 mass % to 99.9 mass %, and particularly preferably 80 mass % to 99 mass % with respect to a total mass of the composition B.

The two-liquid type curable composition set of the present invention may include a composition or an article other than the composition A and the composition B.

The composition other than the composition A and the composition B is not particularly limited, and examples thereof include a cleaning liquid for the surfaces of the adherends to which the composition A and/or the composition B are/is applied, and a removing liquid for cured products of the composition A and the composition B.

In addition, the article is not particularly limited, and examples thereof include application tools such as brush, spatula, cotton swab, roller, and spray for applying the composition A or the composition B, and removal tools such as paper and cloth for removing excess composition A and composition B.

<Method for Manufacturing an Adhered Product Using Two-Liquid Type Curable Composition Set>

A second embodiment of the method for manufacturing an adhered product of the present invention, which is a method for manufacturing an adhered product using the two-liquid type curable composition set of the present invention, includes a step of applying a composition B containing a Lewis acidic compound to a surface of a first adherend; a step of applying a composition A containing a methylene malonate compound to the surface of the first adherend or a surface of a second adherend; and

a step of adhering the surface of the first adherend to which the composition B has been applied and the surface of the second adherend to which the composition A has been applied, or adhering the surface of the first adherend to which the composition A and the composition B have been applied and the surface of the second adherend to each other.

Preferred aspects of the composition A and the composition B in the method for manufacturing an adhered product of the present invention are the same as the preferred aspects of the composition A and the composition B in the two-liquid type curable composition set of the present invention described above.

<Composition B Application Step and Composition A Application Step>

The method for manufacturing an adhered product of the present invention includes a steps of applying a composition B containing a Lewis acidic compound to a surface of a first adhered (also referred to as “composition B application step”): and a step of applying a composition A containing a methylene malonate compound to the surface of the first adherend or a surface of a second adherend (also referred to as “composition A application step”).

The composition B application step and the composition A application step may be performed either first or simultaneously.

In the method for manufacturing an adhered product of the present invention, both the composition A and the composition B may be applied to the surface of one adherend (the surface of the first adherend), and the composition A and/or the composition B may be applied to the surface of the other adherend (the surface of the second adherend), or the composition A may be applied to the surface of one adherend (the surface of the first adherend), and the composition B may be applied to the surface of the other adherend (the surface of the second adherend).

Further, the surface of the first adherend and the surface of the second adherend may be partial surfaces of different adherends, or may be two surfaces that can be adhered in one adherend.

Shapes of the surface of the first adherend and the surface of the second adherend are not particularly limited, and may be any shapes such as flat surfaces, uneven surfaces, or surfaces having an indefinite shape.

An amount of the composition A to be applied in the composition A application step is not particularly limited, and may be any amount in which adhesion can be performed, and can be appropriately selected as desired.

After the application of the composition A, the solvent may be removed by air drying, heat drying, or the like as necessary.

An amount of the composition B to be applied in the composition B application step is not particularly limited as long as adhesion can be performed, but the amount of the Lewis acidic compound to be applied, which is contained in the composition B, is preferably 0.001 parts by mass to 1.0 parts by mass, more preferably 0.001 parts by mass to 0.5 parts by mass, and particularly preferably 0.001 parts by mass to 0.1 parts by mass with respect to 100 parts by mass of an amount of the methylene malonate compound by the composition A in the composition A application step.

After the application of the composition B, the solvent may be removed by air drying, heat drying, or the like as necessary.

The application method used in the composition B application step and the composition A application step is not particularly limited, and the composition B or the composition A can be applied to the surface of the first adherend or the surface of the second adherend by the same method as that in the curable composition application step.

<Adhesion Step>

The method for manufacturing an adhered product of the present invention includes a step of adhering the surface of the first adherend to which the composition B has been applied and the surface of the second adherend to which the composition A has been applied, or adhering the surface of the first adherend to which the composition A and the composition B have been applied and the surface of the second adherend to each other (also referred to as a “second adhesion step”).

In the second adhesion step, the surface of the first adherend and the surface of the second adherend may be overlapped and adhered.

In the second adhesion step, the Lewis acidic compound contained in the composition B acts on the methylene malonate compound contained in the composition A, and the methylene malonate compound is cured, for example, by the moisture content in the air, so that the surface of the first adherend and the surface of the second adherend are adhered to each other.

When the surface of the first adherend and the surface of the second adherend are overlapped, the surface of the first adherend and/or the surface of the second adherend may be moved as necessary to promote mixing of the composition A and the composition B.

In the second adhesion step, the curable composition can be cured even at room temperature (for example, 10° C. to 35° C.), but, in order to promote curing, the surface of the first adherend, the surface of the second adherend, and/or the adherends may be heated. Curing may be performed by heating to a temperature within a range not affecting the adherend, for example, about 35° C. to 100° C. as the heating temperature.

Furthermore, in the second adhesion step, as necessary, pressure may be applied in a direction in which the surface of the first adherend and the surface of the second adherend overlap each other until adhesion is completed.

The adherends to be adhered by the curable composition of the present invention, the two-liquid type curable composition set of the present invention, or the method for manufacturing an adhered product of the present invention are not particularly limited, and may be inorganic compounds, organic compounds, or inorganic-organic composites, and may be of the same material or different materials. In addition, the curable composition of the present invention, the two-liquid type curable composition set of the present invention, or the method for manufacturing an adhered product of the present invention enable adhesion of any solid form.

Examples of the material for the adherend include plastic, rubber, wood, metals, inorganic materials, and paper.

Specific examples of the plastic include cellulose acetate resins such as polyvinyl alcohol, triacetyl cellulose, and diacetyl cellulose, cyclic polyolefin resins using a cyclic olefin as a monomer such as acrylic resins, polyethylene terephthalate, polycarbonate, polyarylate, polyether sulfone, and norbornene, polyvinyl chloride, epoxy resins, and polyurethane resins.

Specific examples of the rubber include natural rubber and styrene-butadiene rubber (SBR).

Specific examples of the wood include natural wood and synthetic wood.

Specific examples of the metal include steel plates, metals such as aluminum and chromium, and metal oxides such as zinc oxide (ZnO) and indium tin oxide (ITO).

Specific examples of the inorganic material include glass, mortar, concrete, and stone.

Specific examples of the paper include paper such as fine paper, coated paper, art paper, simili paper, thin paper, and thick paper, and various synthetic papers.

### EXAMPLES

Hereinafter, the present invention will be specifically described based on Examples. Note that the present invention is not limited to these Examples. In addition, in the following description. “parts” and “%” mean “parts by mass” and “mass %”, respectively, unless otherwise specified.

<Preparation of Diethyl Methylenemalonate>

Diethyl methylenemalonate (hereinafter, also referred to as “DEMM”) manufactured according to the following document was used. Purity: 99 mass % or more (from ¹H-NMR).

Journal of the Chemical Society of Japan, 1972, No. 3, pp. 596-598

<Preparation of Composition B1>

Zinc (II) trifluoromethanesulfonate as a Lewis acidic compound was added to acetone so as to attain a concentration of 0.15 mmol/L, and was completely dissolved therein to prepare a composition B1.

<Preparation of Compositions B2 to B4>

Ytterbium (III) trifluoromethanesulfonate (composition B2), silver (I) trifluoromethanesulfonate (composition B3), or copper (II) trifluoromethanesulfonate (composition B4) as a Lewis acidic compound was added to acetone so as to attain a concentration of 0.15 mmol/L, and completely dissolved to prepare compositions B2 to B4, respectively.

### Example 1

The composition B1 (10 μL) was mixed with diethyl methylene malonate (1 mL), and the solvent was removed by vacuum drying to prepare a curable composition of Example 1.

The obtained curable composition of Example 1 (10 μL) was added dropwise to a test piece (prism having a bottom surface of 12.7 cm×12.7 cm) made of a material as shown in Table 1, and another test piece having the same shape and the same material was bonded thereto. After bonding, the time until an object having a mass of 2.586 kg could be lifted with the adhesive test piece was recorded as a set time. The evaluation results are shown in Table 1. The shorter the set time is, the better the curing rate is.

### Example 2 or 3

A curable composition of Example 2 or 3 was prepared in the same manner as in Example 1 except that the composition B2 or B3, respectively, was used instead of the composition B1, and the set times were each measured. The evaluation results are collectively shown in Table 1.

### Comparative Example 1

The set time was measured in the same manner as in Example 1 except that the composition B1 was not used. However, even after a lapse of 1 hour, no curing occurred, and an object having a mass of 2.586 kg could not be lifted.

TABLE 1

| Material for | | | |
|---|---|---|---|
| test piece | Example 1 | Example 2 | Example 3 |
| Cu | 3 min | 10 sec | 3 min |
| Al | — | 1 min | — |
| PMMA | — | 1 min | — |

“-” in Table 1 represents that measurement had not been performed, and PMMA represents polymethyl methacrylate.

As shown in Table 1, the curable compositions of Examples 1 to 3 can be cured by the moisture content in the air, and are excellent in curing rate.

### Example 4

The composition B1 (10 μL) was applied to an adhered surface of a test piece (prism having a bottom surface of 12.7 cm×12.7 cm), diethyl methylene malonate (1 mL) was added dropwise to an adherend surface of another test piece, and then both surfaces were bonded together and cured. After bonding, the time until a weight of 2.586 kg could be lifted with the adhesive test piece was recorded as a set time. The evaluation results are shown in Table 2.

### Examples 5 to 7

Curable compositions of Examples 5 to 7 were prepared in the same manner as in Example 4 except that the compositions B2 to B4, respectively, were used instead of the composition B1, and the set times were each measured. The evaluation results are collectively shown in Table 2.

### Comparative Example 2

The set time was measured in the same manner as in Example 4 except that the composition B1 was not used. However, even after a lapse of 1 hour, no curing occurred, and an object having a mass of 2.586 kg could not be lifted.

TABLE 2

| Material for | | | | |
|---|---|---|---|---|
| test piece | Example 4 | Example 5 | Example 6 | Example 7 |
| Cu | 3 min | 30 sec | 2 min | 10 sec |
| Al | 5 min | 1 min | — | — |
| PMMA | 3 min | 1.5 min | — | 5 sec |

“-” in Table 2 represents that measurement had not been performed, and PMMA represents polymethyl methacrylate.

As shown in Table 2, the methods for manufacturing an adhered product using the two-liquid type curable composition sets of Examples 4 to 7 can be cured by the moisture content in the air, and provide an excellent curing rate.

### Examples 8 to 11 and Comparative Examples 3 and 4

<Preparation of Composition B5>

The Lewis acidic compounds shown in Table 3 were added to acetone and completely dissolved therein, thereby preparing compositions B5 of Examples 8 to 11 and Comparative Examples 3 and 4, respectively. When the Lewis acidic compound was zinc (II) trifluoromethanesulfonate, the concentration was adjusted to 0.15 mmol/L. and, otherwise, the concentration was adjusted to 0.75 mmol/L.

<Preparation and Evaluation of Curable Composition>

The composition B5 was mixed with 1 mL of the methylene malonate compound shown in Table 3 to attain the concentration (mass %) of the Lewis acidic compound shown in Table 3 in the curable composition, and the solvent was removed by vacuum drying to prepare curable compositions of Examples 8 to 11 and Comparative Examples 3 and 4.

Each of the obtained curable compositions (10 μL) was added dropwise to a test piece (prism having a bottom surface of 12.7 cm×12.7 cm) made of a material as shown in Table 3, and another test piece having the same shape and the same material was bonded thereto. After bonding, the time until an object having a mass of 2.586 kg could be lifted with the adhesive test piece was recorded as a set time. The evaluation results are shown in Table 3. The shorter the set time is, the better the curing rate is.

TABLE 3

| | | | | | | | | | | Comparative | Comparative | |
|---|---|---|---|---|---|---|---|---|---|---|---|---|
| | | Example 8 | | Example 9 | | Example 10 | | Example 11 | | Exampie 3 | Example 4 | |
| Methylene malonate | | DEMM | | DEMM | | DEMM | | DIBMM | | DEMM | DEMM | |
| compound | | | | | | | | | | | | |
| Lewis acidic | Type | Zn(OTf)₂ | | Zn(acac)₂ | | Fe(OTf)₂ | | Zn(OTf)₂ | | Zn(OTf)₂ | Zn(OTf)₂ | |
| compound | Concentration | 0.5 | | 0.05 | | 0.05 | | 0.05 | | 2 | 0.0005 | |
| | (mass %) | | | | | | | | | | | |
| Material for | Cu | 1 | min | 2 | min | 2 | min | 5 | min | Not dissolved | >30 | min |
| test piece | Al | 3 | min | 5 | min | 3 | min | 10 | min | | >30 | min |
| | PMMA | 2 | min | 3 | min | 3 | min | 5 | min | | >30 | min |

Each of the concentrations of the Lewis acidic compounds in Table 3 represents the concentration (mass %) with respect to the total mass of the curable composition.

In Comparative Example 3, an insoluble matter was precipitated after vacuum drying, and the test was impossible. In Comparative Example 4, the effect obtained by adding the Lewis acidic compound was not observed.

Abbreviations shown in Table 3 are as follows.

DEMM: diethyl methylenemalonate

DtBMM: di-t-butyl methylenemalonate

Zn(OTf)₂: zinc (II) trifluoromethanesulfonate

Zn(acac)₂: zinc (II) acetylacetonate

Fe(OTf)₂: iron (II) trifluoromethanesulfonate

As shown in Table 3, the curable compositions of Examples 8 to 11 can be cured by the moisture content in the air, and are excellent in curing rate.

### Examples 12 to 16 and Comparative Example 5

<Preparation of Composition B6>

The Lewis acidic compounds shown in Table 4 were added to acetone and completely dissolved therein, thereby preparing compositions B6 of Examples 12 to 16 and Comparative Example 5, respectively. When the Lewis acidic compound was zinc (II) trifluoromethanesulfonate, the concentration was adjusted to 0.15 mmol/L, and, otherwise, the concentration was adjusted to 0.75 mmol/L.

<Evaluation of Two-Liquid Type Curable Composition Set>

The composition B6 was applied to an adherend surface of a test piece (prism having a bottom surface of 12.7 cm×12.7 cm) in an amount such that the concentration of the Lewis acidic compound with respect to the total mass (except acetone) of the methylene malonate compound and Lewis acidic compound to be used was the concentration (mass %) as shown in Table 4, and 1 mL of the methylene malonate compound as shown in Table 4 was added dropwise to an adherend surface of another test piece, and then both surfaces were bonded together and cured. After bonding, the time until a weight of 2.586 kg could be lifted with the adhesive test piece was recorded as a set time. The evaluation results are shown in Table 4.

TABLE 4

| | | | | | | | | | | | | Comparative | |
|---|---|---|---|---|---|---|---|---|---|---|---|---|---|
| | | Example 12 | | Example 13 | | Example 14 | | Example 15 | | Example 16 | | Example 5 | |
| Methylene malonate | | DEMM | | DEMM | | DEMM | | DEMM | | DIBMM | | DEMM | |
| compound | | | | | | | | | | | | | |
| Lewis acidic | Type | Zn(OTf)₂ | | Zn(acac)₂ | | Ti(OBu)₄ | | Fe(OTf)₂ | | Zn(OTf)₂ | | Zn(OTf)₂ | |
| compound | Concentration | 0.5 | | 0.05 | | 0.05 | | 0.05 | | 0.05 | | 0.0005 | |
| | (mass %) | | | | | | | | | | | | |
| Material for | Cu | 1 | min | 30 | sec | 30 | sec | 1.5 | min | 5 | min | >30 | min |
| test piece | Al | 2 | min | 1 | min | 1 | min | 2 | min | 10 | min | >30 | min |
| | PMMA | 2 | min | 1 | min | 1 | min | 2 | min | 10 | min | >30 | min |

Each of the concentrations of the Lewis acidic compounds in Table 4 represents the concentration of the Lewis acidic compound with respect to the total mass (except acetone) of the methylene malonate compound and the Lewis acidic compound used.

In Comparative Example 5, the effect obtained by adding the Lewis acidic compound was not observed.

An abbreviation, other than those shown above, in Table 4 is as follows.

Ti(OBu)₄: tetrabutoxytitanium (IV)

As shown in Table 4, the curable compositions of Examples 12 to 16 can be cured by the moisture content in the air, and are excellent in curing rate.

The disclosure of Japanese Patent Application No. 2019-164834 filed on Sep. 10, 2019 is incorporated herein by reference in its entirety.

All documents, patent applications, and technical standards described herein are incorporated herein by reference to the same extent as if each document, patent application, and technical standard are specifically and individually indicated to be incorporated by reference.

1. A curable composition comprising:
a methylene malonate compound; and
a Lewis acidic compound.

2. The curable composition according to claim 1, wherein the methylene malonate compound is a compound represented by the following formula (1) or formula (2): 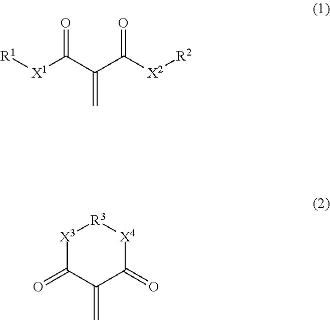
in the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

3. The curable composition according to claim 1, wherein the Lewis acidic compound includes a Lewis acidic compound having a metal cation.

4. The curable composition according to claim 1, wherein the Lewis acidic compound includes a Lewis acidic compound having at least one metal cation selected from the group consisting of Fe²⁺, Cu²⁺, Zn²⁺, Ag⁺, Yb³⁺, and Ti⁴⁺.

5. The curable composition according to claim 1, wherein the Lewis acidic compound includes a Lewis acidic compound having at least one counter anion selected from the group consisting of a trifluoromethanesulfonic acid anion, a tert-butoxide anion, an acetylacetonate anion, a chloride ion, and a bromide ion.

6. The curable composition according to claim 1, wherein a content of the Lewis acidic compound is 0.001 parts by mass to 1.0 parts by mass with respect to 100 parts by mass of a content of the methylene malonate compound.

7. The curable composition according to claim 2, wherein the X¹ to X⁴ are each independently O or NR.

8. The curable composition according to claim 2, wherein the X¹ to X⁴ are O.

9. The curable composition according to claim 2, wherein the R¹ and R² are each independently an alkyl group.

10. The curable composition according to claim 2, wherein the R³ is an alkylene group.

11. The curable composition according to claim 2, which comprises the compound represented by the formula (1).

12. A method for manufacturing an adhered product, comprising:
a step of applying the curable composition according to claim 1 to a surface of a first adherend; and
a step of adhering the surface of the first adherend to which the curable composition has been applied and a surface of a second adherend to each other.

13. A two-liquid type curable composition set comprising:
a composition A comprising a methylene malonate compound; and
a composition B comprising a Lewis acidic compound.

14. The two-liquid type curable composition set according to claim 13, wherein the methylene malonate compound is a compound represented by the following formula (1) or formula (2): 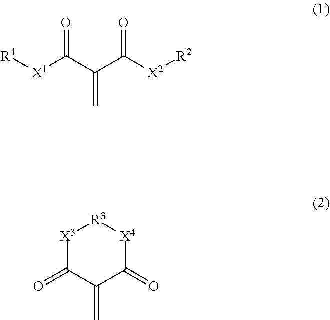
in the formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.

15. A method for manufacturing an adhered product, comprising:
a step of applying a composition B comprising a Lewis acidic compound to a surface of a first adherend;
a step of applying a composition A comprising a methylene malonate compound to the surface of the first adherend or a surface of a second adherend; and
a step of adhering the surface of the first adherend to which the composition B has been applied and the surface of the second adherend to which the composition A has been applied, or adhering the surface of the first adherend to which the composition A and the composition B have been applied and the surface of the second adherend to each other.

16. The method for manufacturing an adhered product according to claim 15, wherein the methylene malonate compound is a compound represented by the following formula (1) or formula (2): 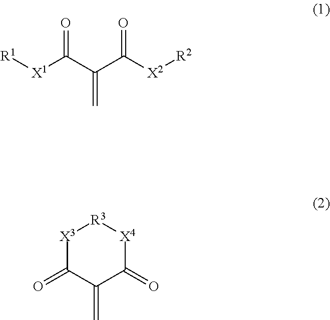
in formulae (1) and (2), X¹ to X⁴ each independently represent O, NR, or C(R)₂, R's each independently represent a hydrogen atom, an alkyl group, or an aryl group, R¹ and R² each independently represent an alkyl group or an aryl group, and R³ represents an alkylene group, an arylene group, or a group obtained by combining two or more of these groups.
